(19) United States
(12) Patent Application Publication
(10) Pub. No.: US 2006/0048713 A1
(43) Pub. Date: Mar. 9, 2006

(54) Methods and systems for optimizing a body of water to support the health of particular fish species

(76) Inventors: Robert J. Congel, Fayetteville, NY (US); Robert D. Lusk, Sadler, TX (US)

Correspondence Address: JEFFREY L. BRANDT;c/o PORTFOLIO IP, P.O. BOX 52050, MINNEAPOLIS, MN, 55402, US

(21) Appl. No.: 11/212,484

(22) Filed: Aug. 26, 2005

Related U.S. Application Data
(60) Provisional application No. 60/607,093, filed on Sep. 3, 2004.

(51) Int. Cl. A01K 61/00

(52) U.S. Cl. 119/215

(57) ABSTRACT

Methods and systems for optimizing the characteristics of a body of water to support the health of one or more selected species of fish. One or more intervention techniques are identified and implemented to adjust the characteristics of the body of water to support the optimum health of the selected species of fish, thereby facilitating recreational activities and food development and harvesting.

### BACKGROUND

Currently, fish species tend to develop and flourish in both managed and unmanaged bodies of water subject to the natural influences and characteristics of the bodies of water. Where efforts are undertaken to engineer or otherwise influence previously unmanaged bodies of water, these efforts have been directed to increasing the naturally occurring characteristics thereof.

Factors relating to fish species introduction into any particular body of water may include geographical location, accidental or intentional introduction of fish species, and others. In some instances fish are intentionally introduced into a body of water with the expectation of developing sport or recreational fishing or food development. Factors relating to the health of the fish relate to water, habitat and environmental characteristics of the body of water. Water quality and related environmental conditions, however, are not necessarily supportive of the health of either indigenous or introduced fish populations.

Generally, the success or failure of a fish species within a body of water has been a function of the natural characteristics of the body of water, whether unmanaged or enhanced through human intervention. Even where fish species multiply within a body of water, the water and environment may be such that the health of the fish themselves is far from optimal.

### SUMMARY OF THE INVENTION

The present invention provides methods and systems for optimizing the characteristics of a body of water to support the health of one or more selected species of fish. More particularly, one or more intervention techniques are identified and implemented to adjust the characteristics of the body of water to support the optimum health of the selected species of fish. This is in contrast to the above-described prior art of either leaving a body of water unmanaged or taking steps to enhance the naturally occurring characteristics of a body of water. Using the present invention, optimal health of selected species of fish can be promoted in selected bodies of water, facilitating a variety of activities including recreational activities and food development and harvesting.

### DESCRIPTION OF THE DRAWING FIGURES

These and other objects, features and advantages of the invention will be apparent from a consideration of the detailed description of the invention when read in conjunction with the drawing Figures, in which:

FIG. 1 is a flow chart describing a process for adjusting the characteristics of a body of water to optimize the health of selected species of fish in accordance with the present invention.

### DETAILED DESCRIPTION OF THE INVENTION

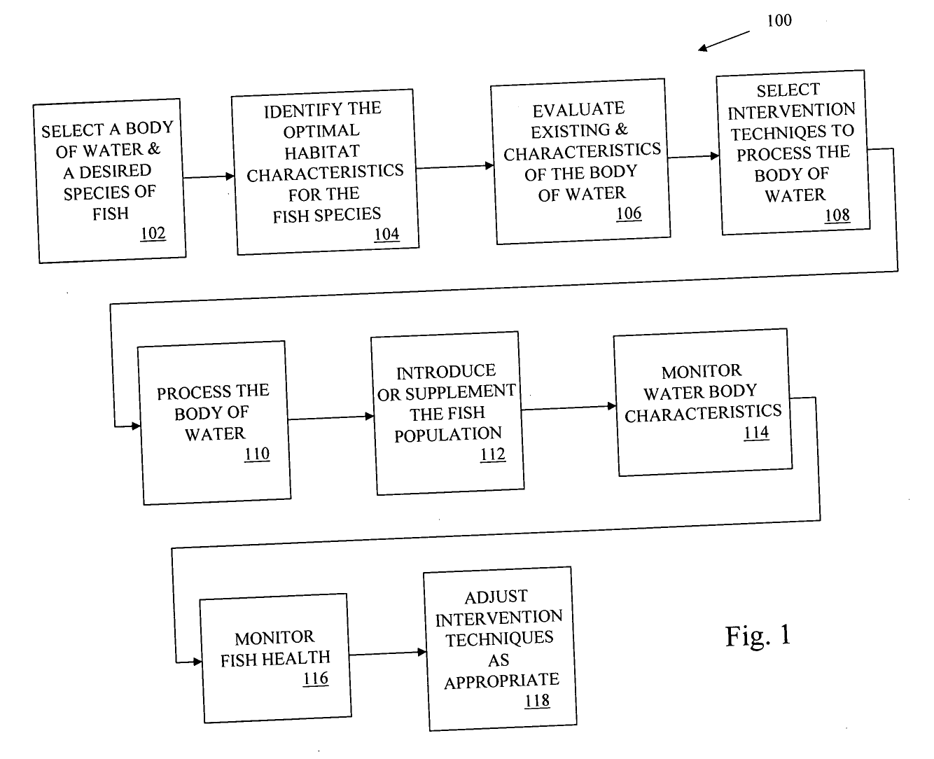

With reference to FIG. 1, there is shown a process 100 for adjusting or altering the characteristics of a body of water to support a selected species of fish in optimal health. The body of water may comprise, for example, a man-made body such as a reservoir or engineered lake or pond or a natural body of water such as a natural lake or pond.

With reference to FIG. 1, initially there is selected a body of water and a species of fish desired to prosper in optimal health within the body of water (step 102). The species of fish may be indigenous or introduced. The optimal environmental characteristics for the selected species of fish is determined (step 104), for example through consultation of historically published naturalist data.

The existing characteristics of the body of water are evaluated (step 106) and intervention techniques are selected to adjust the characteristics of the body of water to meet the desired characteristics optimal to the health of the selected fish species (steps 106, 108). Exemplary body of water characteristics to be evaluated and altered include: plantings, water chemistry, water temperature, physical characteristics such as depth, water current flow, existing flora, existing water organism species, existing water bacterial content and species, contaminant contents such as metals, existing food chain and others as will be apparent to the reader.

Interventions to alter the characteristics of the body of water include, for example: temperature changes, physical changes such as depth, chemical composition changes such as changes to the nitrogen, phosphorous and potassium content, introduction or elimination of flora, introduction or elimination of organisms, introduction or elimination of bacteria, changes to water inflow and outflow rate and others as will now be apparent to the reader. It will be understood that the goal of such interventions is to alter the characteristics of the body of water, if necessary away from the naturally occurring characteristics, so as to promote the optimal health of the selected species of fish, which may then be introduced into and/or supplemented within the body of water (step 112).

Subsequently, several different monitoring techniques are employed to measure the success of the interventions, the characteristics of the body of water and the health of the fish. Water body characteristics may be monitored on both a real-time and periodic basis (step 114). Fish health and proliferation may be monitored on both a real-time and periodic basis (step 116). Fish health may be characterized, for example, by characteristics such as quantity/proliferation, size, weight, growth rate, skin and body chemical composition and other characteristics as will now be apparent to the reader. Dependent on the results of the monitoring, intervention techniques may be adjusted periodically and/or in real time and/or new or different techniques selected and implemented (step 118).

The present invention thus enables operators to select and process bodies of water such that the health of selected species of fish is likely to be optimized within those bodies of water. The invention enables operators to introduce and nourish selected species of fish in selected geographical areas. Benefits include the ability to promote recreational fishing, to develop healthy sources of human nourishment and others as will be apparent to the reader.

What is claimed is:

1. A method for optimizing a body of water to promote the health of a selected species of fish, comprising:
selecting a species of fish;
determining desirable habitat conditions to promote the health of the fish;
selecting a body of water;
determining the initial conditions of the selected body of water;
selecting intervention techniques for the selected body of water;
processing the selected body of water using the selected intervention techniques to obtain the desirable habitat conditions;
introducing or augmenting the selected species of fish within the selected body of water;
monitoring the ongoing conditions of the selected body of water;
monitoring the health of the selected species of fish; and
adjusting, dependent on the monitoring the ongoing conditions of the selected body of water and the monitoring of the health of the selected species of fish, the intervention techniques.
